(19) United States
(12) Patent Application Publication
(10) Pub. No.: US 2018/0319233 A1
(43) Pub. Date: Nov. 8, 2018

(54) A CONVERSION ARRANGEMENT

(71) Applicant: Rail Pro Limited, Victoria ,Mahe (SY)

(72) Inventor: Johannes Jacobus FOURIE, Cornwall Hill (ZA)

(21) Appl. No.: 15/775,387

(22) PCT Filed: Nov. 11, 2016
(86) PCT No.: PCT/ZA2016/050045

§ 371 Date: May 10, 2018

(30) Foreign Application Priority Data
Nov. 11, 2015 (ZA) 2015/08302

(51) Int. Cl. B60F 1/04; F16H 9/24

(52) U.S. Cl. CPC B60F 1/043; B60F 2301/04; F16H 9/24

(57) ABSTRACT

According to the invention there is provided a conversion arrangement for converting a road-going vehicle into a vehicle which is also able to travel on a railway which includes: front and rear rail wheelsets in the form of axles having a pair of rail wheels mounted thereon, front and rear support frames which are mounted rotatably on their respective axles, front and rear mounting means for allowing part of the front and rear support frames to be mounted on a road-wheel-assembly of a road-going vehicle, front and rear displacement means for inter-connecting the front and rear support frames and cross-members of a chassis of the road-going vehicle and for displacing the front and rear support frames and with them, the front and rear rail wheelsets, between an extended rail-going condition and a retracted road-going condition.

### FIELD OF THE INVENTION

This invention relates to a conversion arrangement for converting a road-going vehicle into a vehicle which is also able to travel on a railway and to a vehicle which is able to travel on a road and a railway. The invention further relates to displacement means for allowing a road-and-railway-going vehicle to be displaced between a road and railway travelling condition and to a drive arrangement for driving rail wheels of a road-and-railway-going vehicle.

### SUMMARY OF THE INVENTION

According to a first aspect of the invention there is provided a conversion arrangement for converting a road-going vehicle into a vehicle which is also able to travel on a railway which includes:

a front rail wheelset in the form of an axle having a pair of rail wheels mounted thereon;

a front support frame which is mounted rotatably on the front axle;

a front mounting means for allowing a part of the front support frame to be mounted on a front road-wheel-assembly of a road-going vehicle;

a front displacement means for inter-connecting the front support frame and a cross-member of a chassis of the road-going vehicle arranged forward the front road-wheels and for displacing the front support frame and with it, the front rail wheelset, between a rail-going condition wherein the front rail wheelset is received complementally a railway track and the front road-wheel-assembly is supported clear of the ground and a retracted road-going condition wherein the front rail wheelset is moved to a position where the front road-wheel-assembly supports the front rail wheelset clear of the ground;

a rear rail wheelset in the form of an axle having a pair of rail wheels mounted thereon;

a rear support frame which is mounted rotatably on the rear axle;

a rear mounting means for allowing a part of the rear support frame to be mounted a rear road-wheel-assembly of the road-going vehicle;

a rear displacement means for inter-connecting the rear support frame and a cross-member of a chassis of the road-going vehicle arranged rearward the road-wheels and for displacing the rear support frame, and with it the rear rail wheelset, between a rail-going condition wherein the rear rail wheelset is received complementally a railway track and the rear road-wheel-assembly is supported clear of the ground and a retracted road-going condition wherein the rear rail wheelset is moved to a position where the rear road-wheel-assembly supports the rear rail wheelset clear of the ground.

The front and rear rail wheelsets may be in the form of conventional rail wheelsets currently available on the market, typically having conventional rail wheels which are fast the ends of the axles.

The front and rear support frames may be generally U-shaped, each support frame preferably having a pair of arms which extend from support members which span between and interconnect the pairs of arms of the respective support frames. The front and rear support members are typically sized to correspond with the length of the front and rear axles of the front and rear rail wheelsets respectively. The support members may have a generally triangular shaped central portion when viewed in plan. Bearing members for rotatably interconnecting the front and rear support members with the front and rear axles of the front and rear rail wheelsets respectively may be arranged towards opposing end regions of the front and rear support members.

The rear support frame may include a strengthening portion which may be located a central portion of the rear support frame for improving the flexural strength of the rear support frame. A further strengthening strap for improving the flexural strength of the rear support frame may extend generally between operative underside end regions of the rear support frame.

The front and rear mounting means may include a base portion which is configured to be fastened to a front and a rear axle of the front and rear road-wheel-assemblies respectively. The front and rear mounting means may also include a connecting means for allowing pivotal interconnection between the base portion and the arms to facilitate displacement of the front and rear rail wheelsets between the rail engaging and retracted road-going conditions.

The front and rear displacement means may be in the form of scissor jack assemblies which may extend between and interconnect the front and rear chassis cross-members and the front and rear support members respectively. The scissor jack assemblies may include opposing scissor linkages and an actuator for displacing the linkages between the road and rail going conditions. The actuators may be in the form of any suitable screw threaded rod or piston arrangement. The piston arrangements may be energised pneumatically or hydraulically.

The front displacement means may be in the form of an elongate actuator assembly which may extend between and interconnect the front cross-member and the front support frame. The elongate actuator assembly may be in the form of a conventional piston and cylinder arrangement which may be hydraulically or pneumatically energised between an extended rail-going condition and a retracted road-going condition.

The actuator assembly may include a retaining means for retaining the piston and cylinder in the retracted road-going condition. The retaining means may be in the form of a latch and catch arrangement which is located a region intermediate the piston and cylinder.

A safety mechanism may be provided for maintaining the piston and cylinder in an extended rail-going condition in the event of failure of the actuator assembly. The safety mechanism may be in the form of a shroud or channel which is configured to receive the piston complementally therein in the extended rail-going condition. The shroud may be displaceable, preferably pivotally, between a safety condition wherein the cylinder and piston are maintained in the extended rail-going condition and an inoperative condition wherein the shroud is folded away from the piston and cylinder during the retracted road-going condition.

A mounting member may be provided for allowing the actuator assembly to be mounted on the chassis, the mounting member preferably being configured to extend between and interconnect opposing longitudinal members of a chassis of a road-going vehicle. The mounting member may be in the form of a saddle having a generally arcuate central portion and opposing end regions which are configured to be connectable to the longitudinal members of the chassis. More particularly, the location of the mounting member forward the front cross-member of the chassis is advantageous in that it takes advantage of excess space in the region of the engine of the vehicle.

The linkages may be pivotally connected to the chassis cross-members and/or the support members via pivotable connecting members. The pivotable connecting members may include spherical bush-and-bearing arrangements to allow the road and rail axles to remain substantially parallel each other in the road and rail going conditions.

Guide means, preferably in the form of gears on opposing linkages, may be provided to facilitate uniform guidance during displacement of the linkages between the rail- and road-going conditions. It is to be appreciated that the guidance means may aid in the smooth transition of the wheelsets between an initial position wherein the rail and road wheels both rest on the railway track and the road wheels serve to supplement traction at an initial stage to facilitate the initial displacement of the road-and-rail going vehicle on the railway track, whereafter the guide means will preferably allow the rail wheelset to be displaced smoothly towards the rail going condition at a predetermined desired speed of the vehicle. Typically, at least the rear rail set and the rear road wheels may be arranged in line with each other.

The front road wheels may include a retaining mechanism for retaining the front road wheels in line with the rear road wheels and the railway track. Typically, the vehicle may include a pair of rear wheels arranged opposite both ends of the axle to permit inner wheels of the opposing pairs to be aligned with and carried by the railway track. Typically, the front and rear wheel assemblies may be modified to permit the front and rear wheel assemblies to be in alignment with the railway track.

A biasing means, typically in the form of conventional spring members, may be provided to bias selectively, the linkages towards the rail- and/or road-going condition.

A retaining means may be provided for retaining the linkages in the road-going condition. The retaining means may be in the form of a latch and catch which extend from opposing junctions of the linkages.

A moving means may be provided to move the latch out of a latched condition when the rail wheelsets are displaced out of the road-going condition and towards the rail going condition. The moving means may be in the form of a piston cylinder arrangement. The piston arrangement may be energised pneumatically or hydraulically.

A holding means may be provided for holding the latch and catch in the latched condition. The holding means may be in the form of a conventional helical spring.

A restraining means may be provided to restrain the road wheels and leaf springs of the vehicle in a restrained condition wherein they are moved towards and restrained in position relative the chassis so as to reduce any dynamic effect that may occur through displacement of the road wheel assembly when the vehicle is in the rail-going condition. The restraining means may include a mechanical advantage means, preferably in the form of a pulley-and-cable arrangement for urging and holding the road wheels and leaf springs in the restrained rail-going condition.

A rail wheel brake system may be provided for facilitating braking of the rail wheels in the rail going condition. The brake system may be in the form of any suitable conventional rail wheel brake system. The brake system may include any suitable conventional emergency brake that may be biased to engage or brake the brake system in the event of a failure thereof. The rail wheel brake system may include conventional pneumatically energised rail wheel brakes having pressure chambers which are arranged to extend outwardly from inner walls of the front and rear u-shaped support frames respectively. The brake system may include a cantilever linkage which extends between the pressure chambers and the front and rear rail wheels respectively.

A rear shock absorbing means may be provided for absorbing shock loads between the rear displacement means and a cross member of the chassis while the vehicle is moving on the rail in the rail-going condition due to uneven rail surfaces. The shock absorbing means may include a receiving member which is configured to be received complementally a receiving zone of the rear cross-member. The receiving member may include a base and a pair of opposing sides which extend from the base. Outer facing regions of the base and sides may be overlayed, substantially, with any suitable resiliently deformable material to facilitate energy absorption of shock loads between the rear displacement means and the chassis. The resiliently deformable member may be made of rubber or any suitable compressible synthetic plastics material. The rubber members may serve to absorb compressive and/or shear forces between the receiving member and the rear cross-member.

The conversion arrangement as hereinbefore described, may be modified to include a self-steering means for automatically steering the front and rear rail wheelsets during operation of the vehicle in the rail-going condition. The self-steering means may be in the form of the inventions described in South African patents having numbers ZA2003/09182 and ZA2013/03154 and entitled Self Steering Rail Vehicle and Self-Steering Railway Bogie, respectively.

According to a further aspect of the invention there is provided a drive arrangement or satellite transfer case for driving rail wheels of a road-and-railway-going vehicle which drive arrangement includes:

a drive means which is configured to co-operate with and be driven by a drive shaft of the road-and-rail going vehicle;

a driven means which is configured to co-operate with and be driven, preferably selectively, by the drive means;

a rail wheel drive shaft which is configured to co-operate with and be driven by the driven means;

a rail wheelset connector for allowing driving interconnection between the rail wheel drive shaft and a rail wheelset of the road-and-rail going vehicle.

The satellite transfer case may include a housing for housing at least the drive and driven means.

A chain means, preferably a silent chain and/or belt may be provided to facilitate driving communication between the drive and driven means.

Alternatively, a toothed gear may be provided to facilitate driving communication between the drive and driven means.

The satellite transfer case may include a creep drive means for allowing selective creep drive displacement of the rail wheel drive shaft, and with it, the rail wheels of the rail wheelset.

The satellite transfer case may include a selector means for allowing selective engagement and/or disengagement of the group including the drive means, the driven means, the drive shaft of the road-and-rail going vehicle, the rail wheel drive shaft, the rail wheelset connector, the creep drive means and the chain means. The selector means may be in the form of any suitable selector piston and “dog” clutch assembly for allowing said selective engagement described herein above.

The satellite transfer cases may be provided for and configured to allow selective engagement during driving, either or both of the front and rear wheelsets.

### DETAILED DESCRIPTION OF THE DRAWINGS

A road-and-rail going vehicle and conversion arrangement for converting a road-going vehicle into a vehicle which is also able to travel on a railway in accordance with the invention and various aspects thereof will now be described by way of various examples with reference to the accompanying non-limiting drawings.

In the drawings:

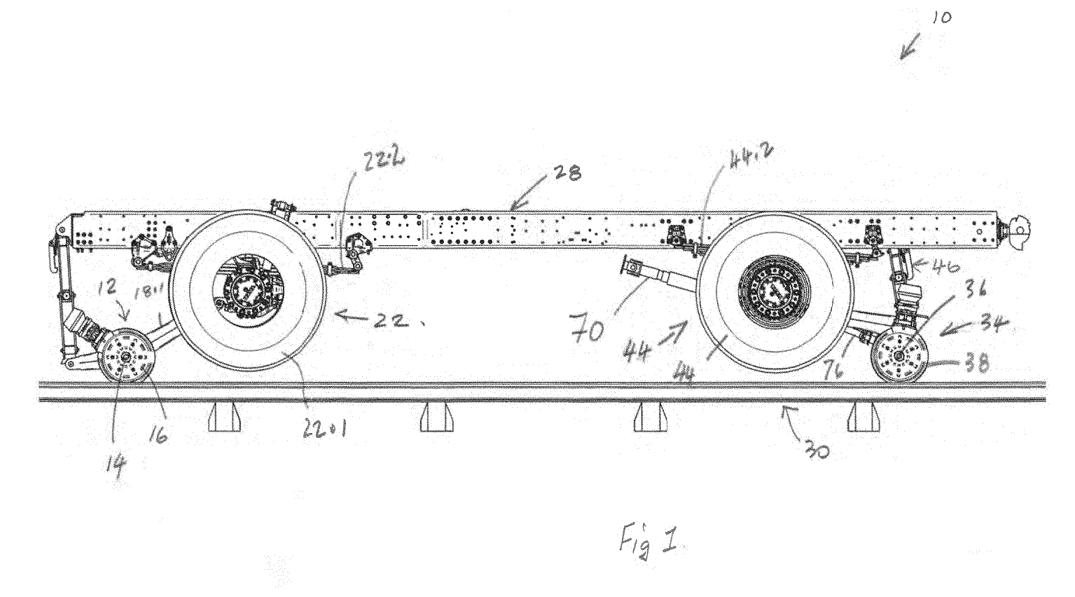

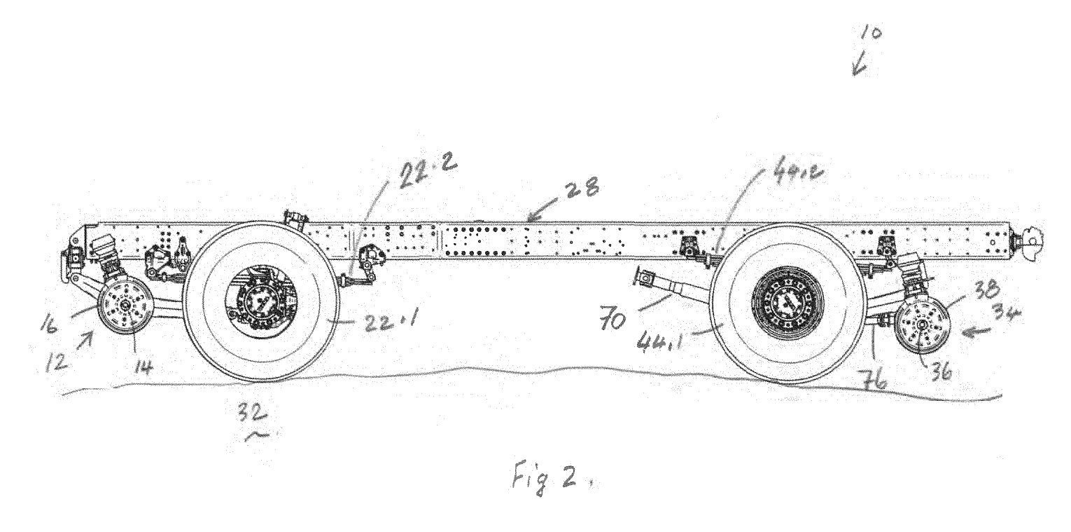

FIGS. 1 and 2 show side views of a portion of a road-and-rail going vehicle in accordance with the invention in a rail- and a road-going condition respectively;

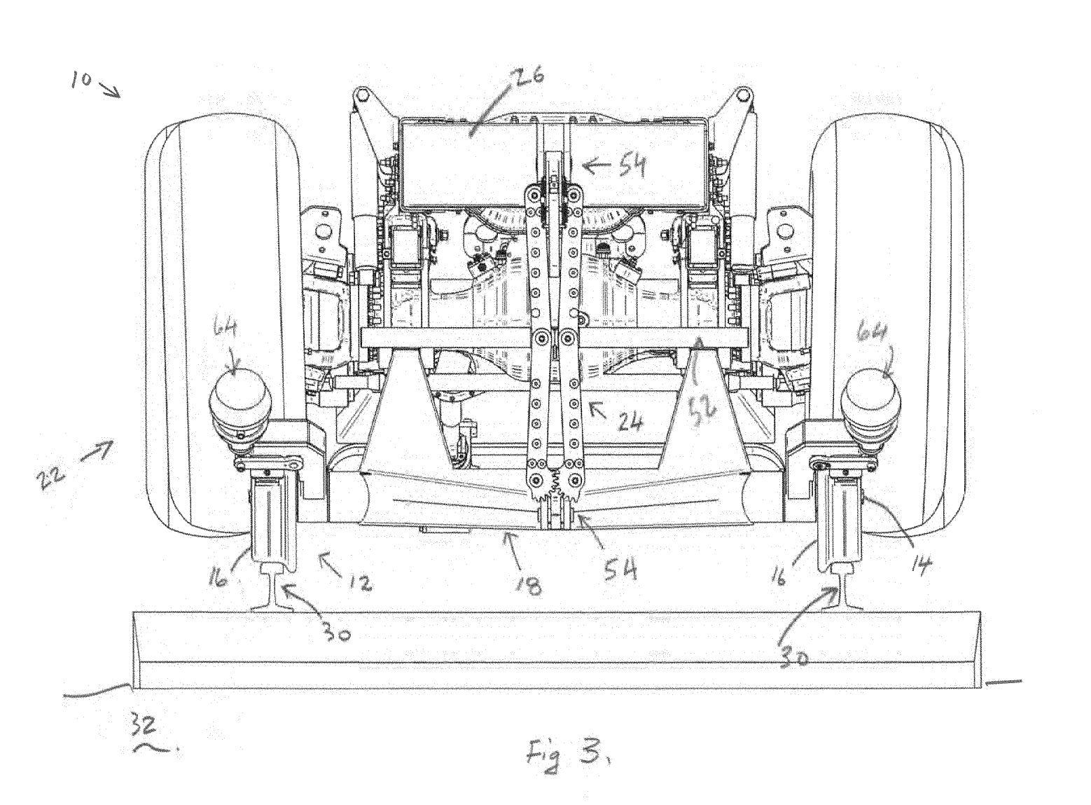

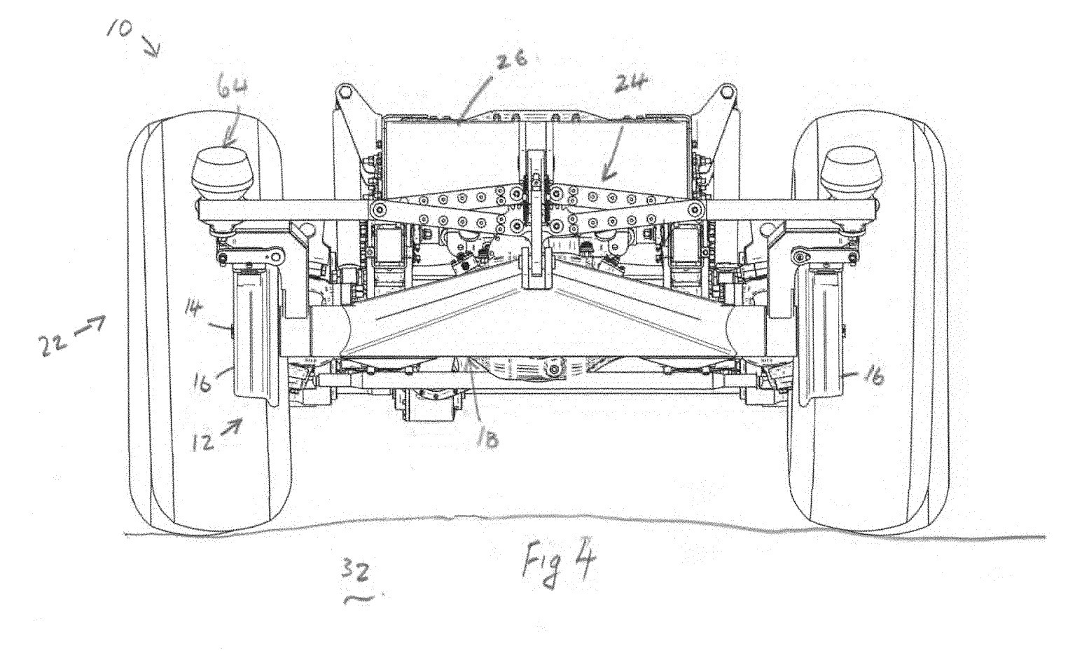

FIGS. 3 and 4 show front views of the vehicle shown in FIGS. 1 and 2 respectively;

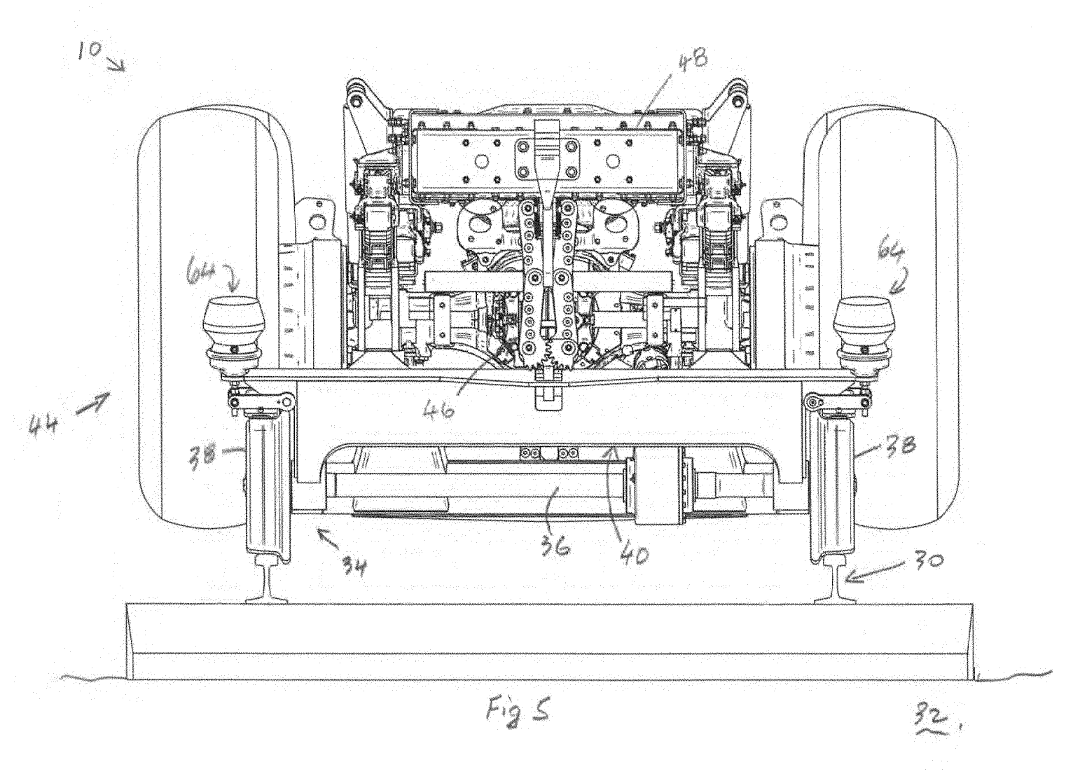

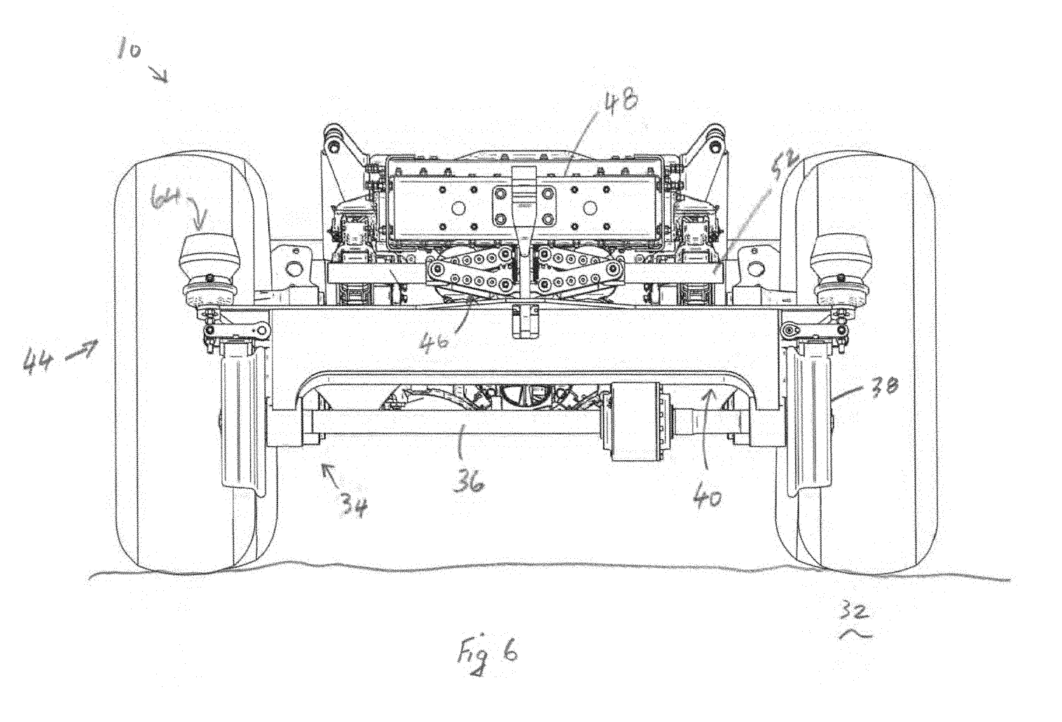

FIGS. 5 and 6 show rear views of the vehicle shown in FIGS. 1 and 2 respectively;

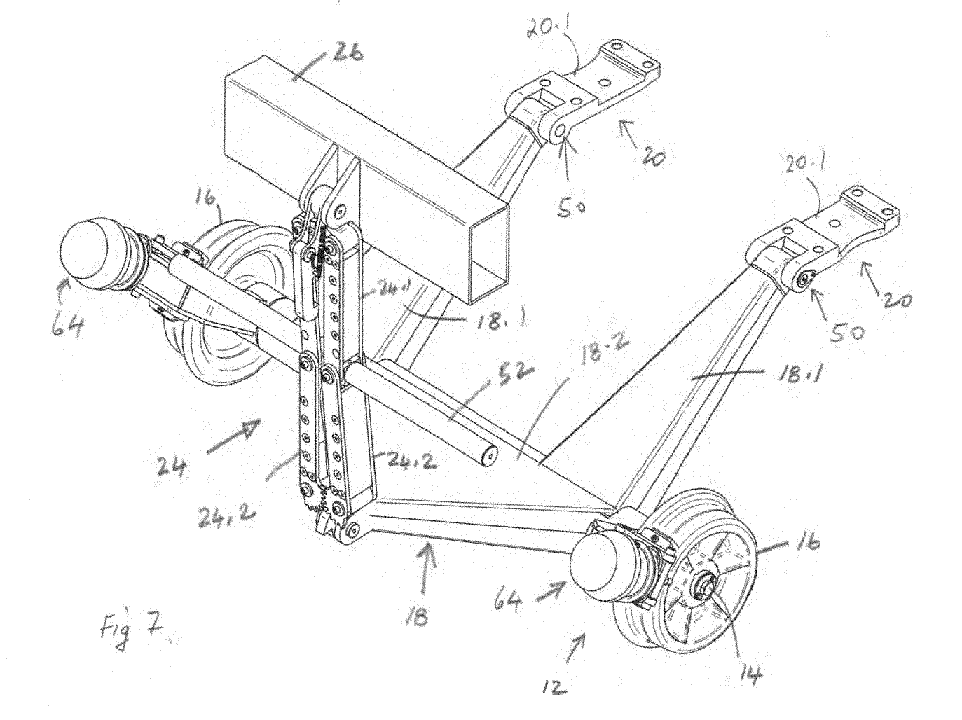

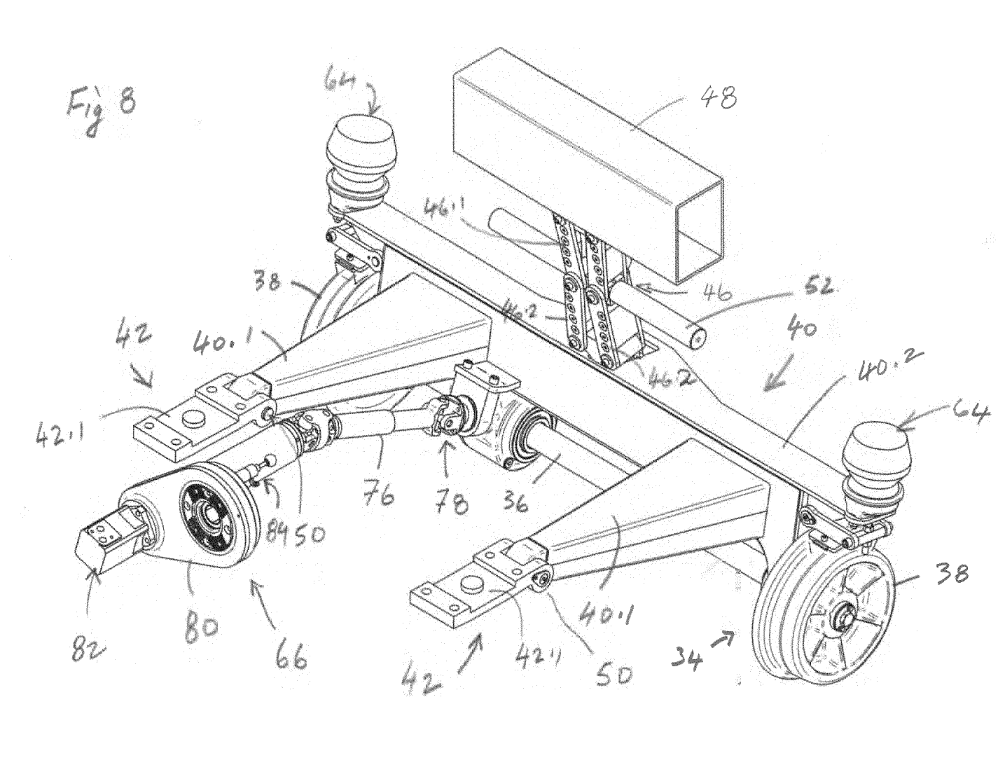

FIGS. 7 and 8 show three-dimensional views of a part of the front and rear rail wheel assemblies shown in FIGS. 3 and 5 respectively;

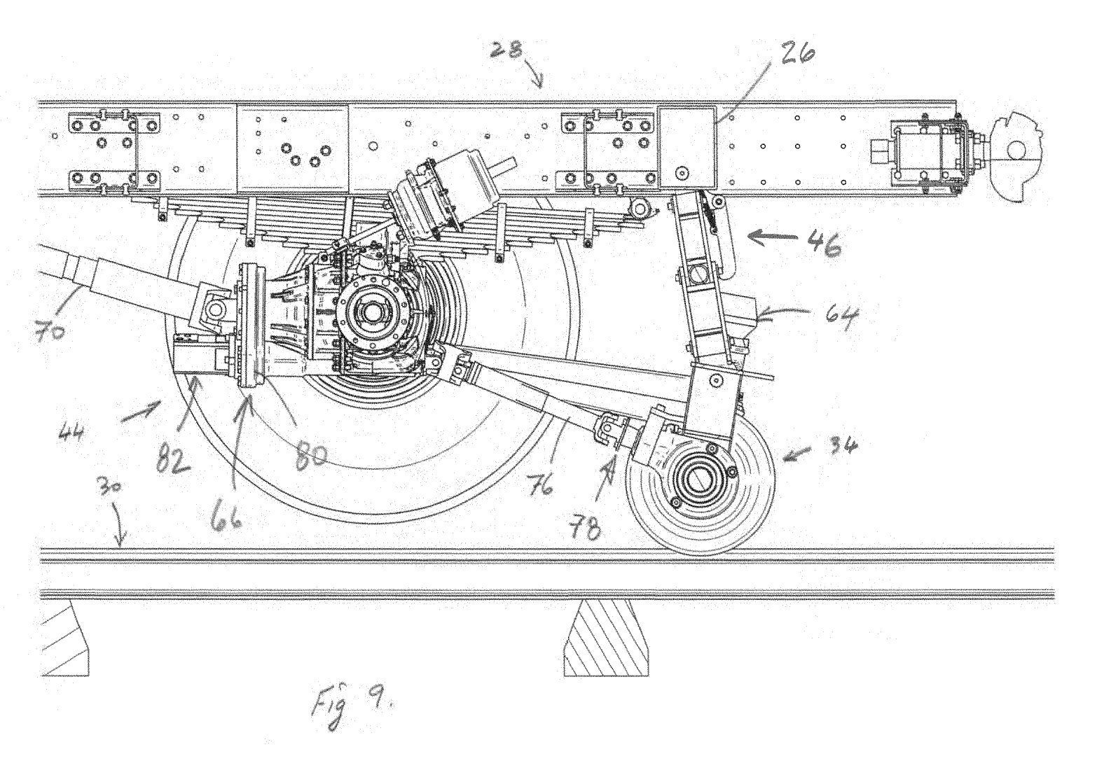

FIG. 9 is an enlarged sectional side view of a rear portion of the vehicle shown in FIG. 1;

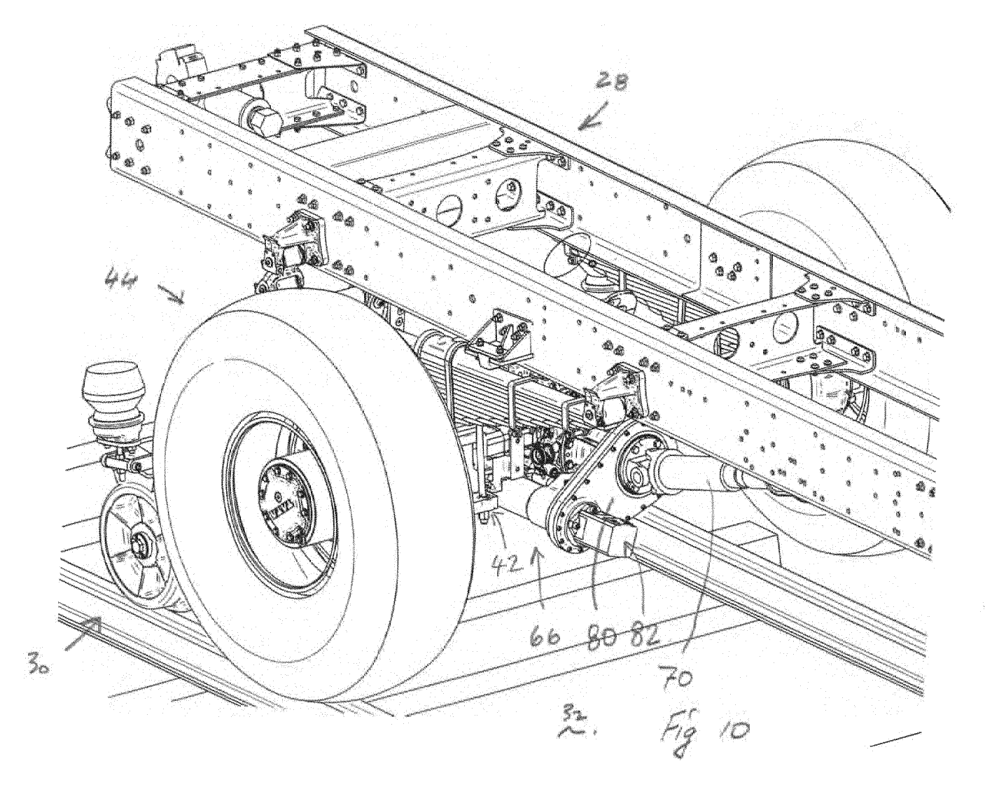

FIG. 10 is an enlarged three-dimensional view of a rear portion shown in FIG. 9;

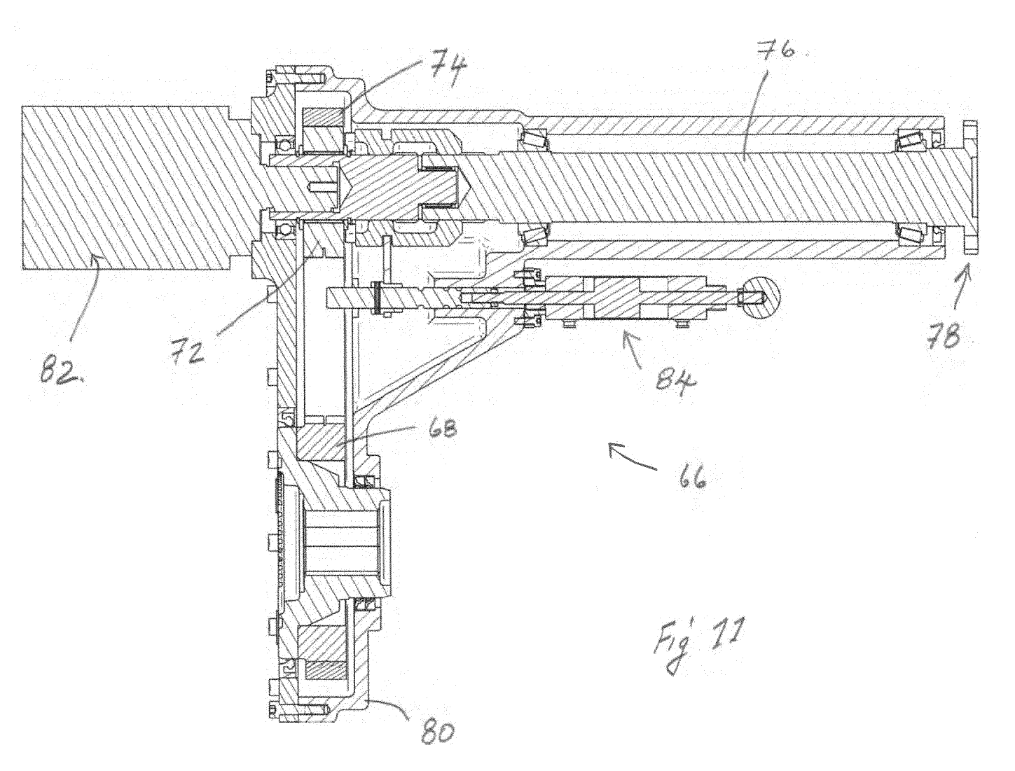

FIG. 11 is a sectional view of a part of a transfer case in accordance with the invention;

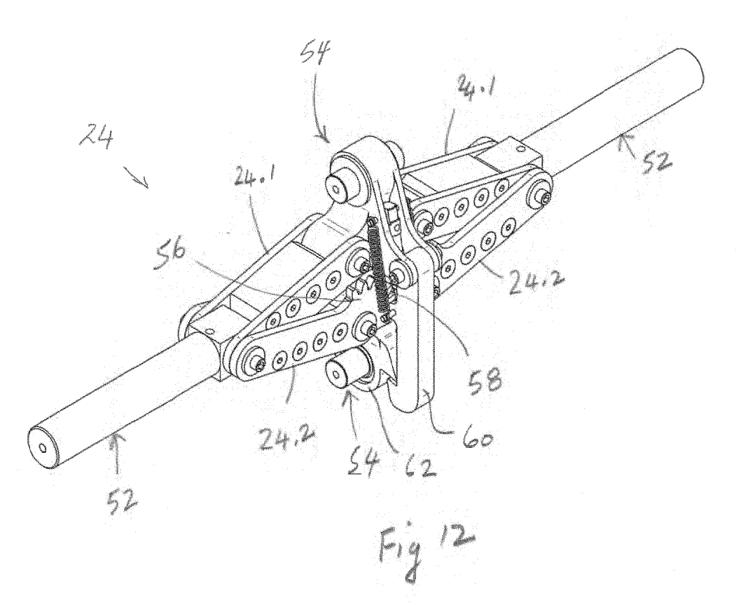

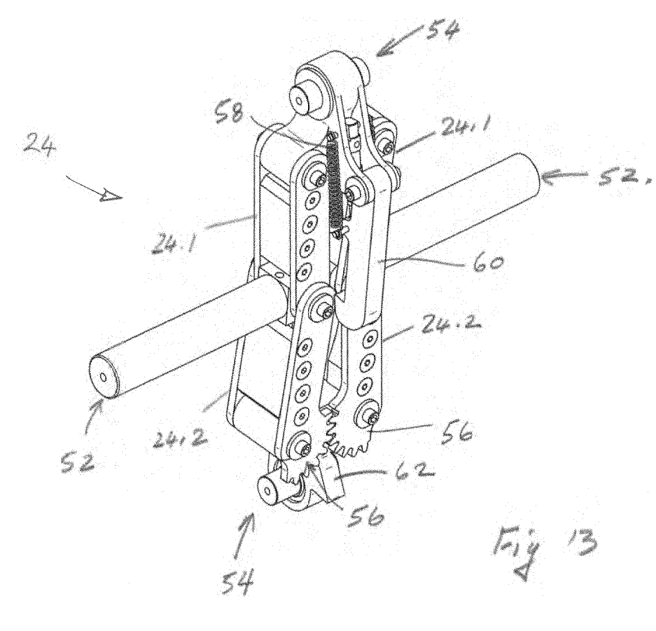

FIGS. 12 and 13 are enlarged three dimensional views of a scissor jack assembly in a retracted and rail-going condition respectively;

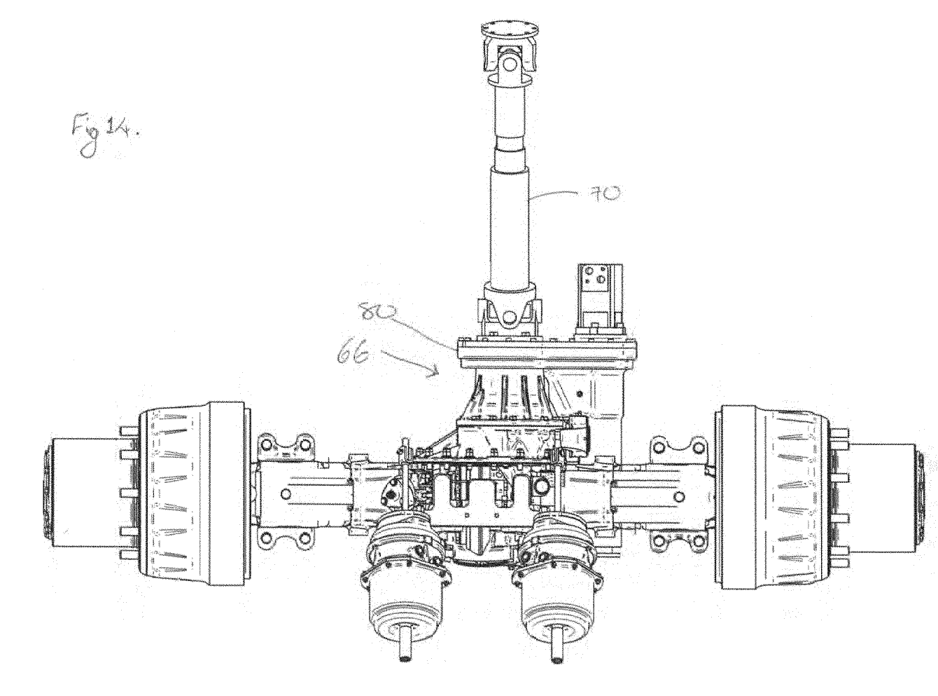

FIG. 14 shows an enlarged three-dimensional view of a transfer case mounted on an axle;

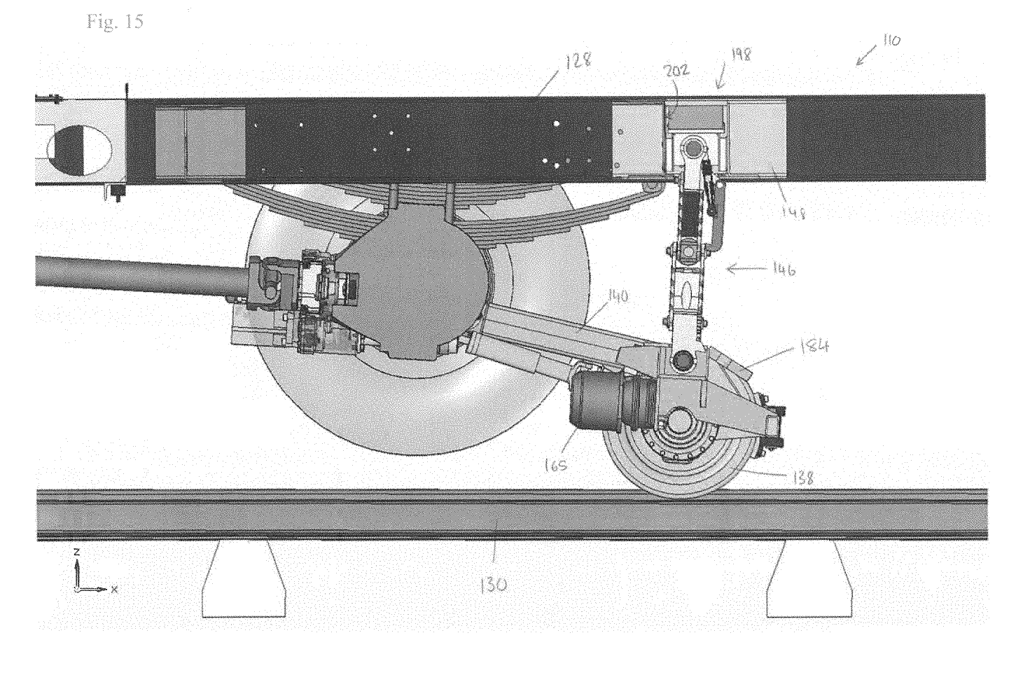

FIG. 15 shows an enlarged sectional side view of a rear portion of a road-rail-vehicle of a second embodiment in accordance with the invention;

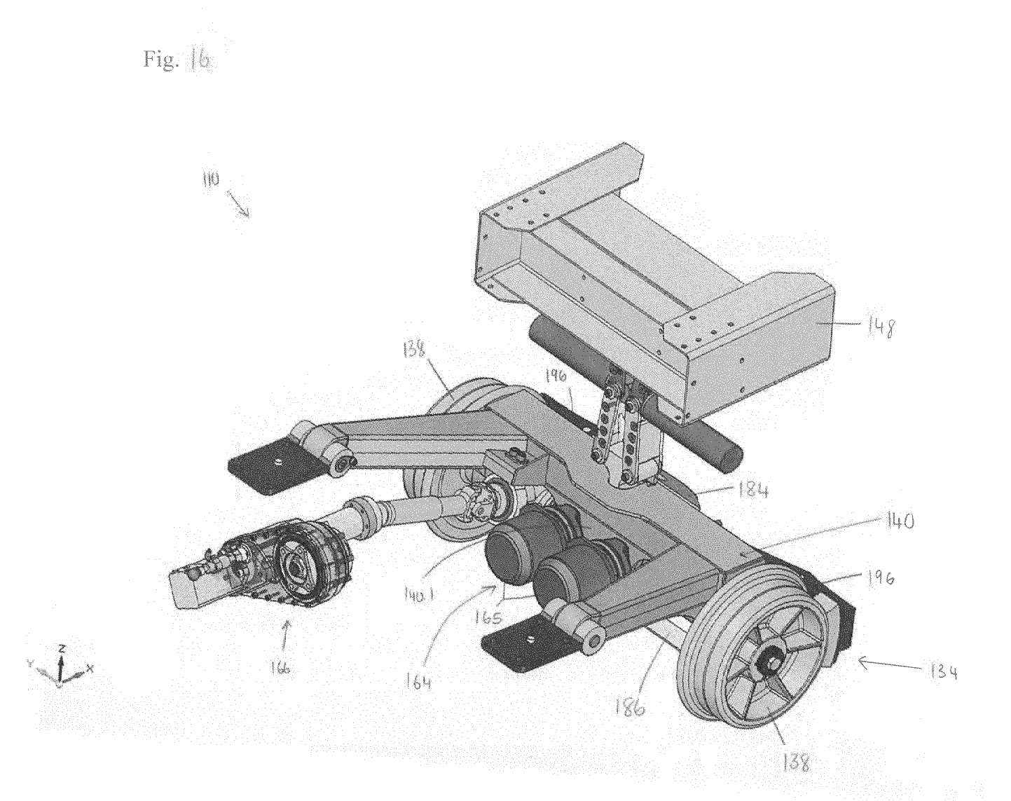

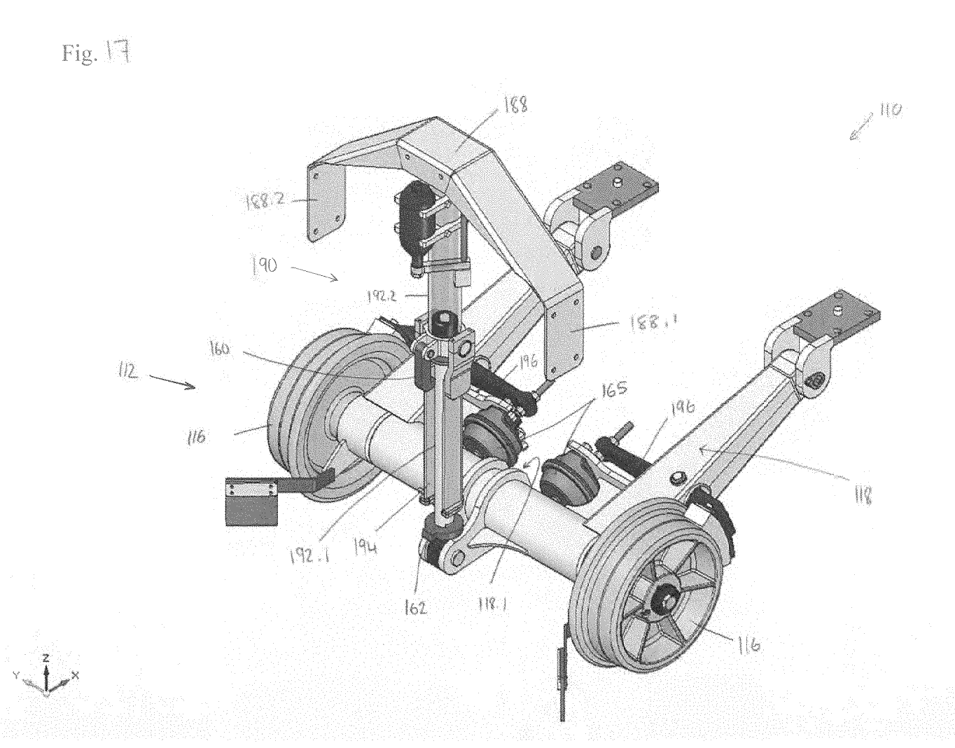

FIGS. 16 and 17 show three-dimensional views of a part of the front and rear rail wheel assemblies of the second embodiment;

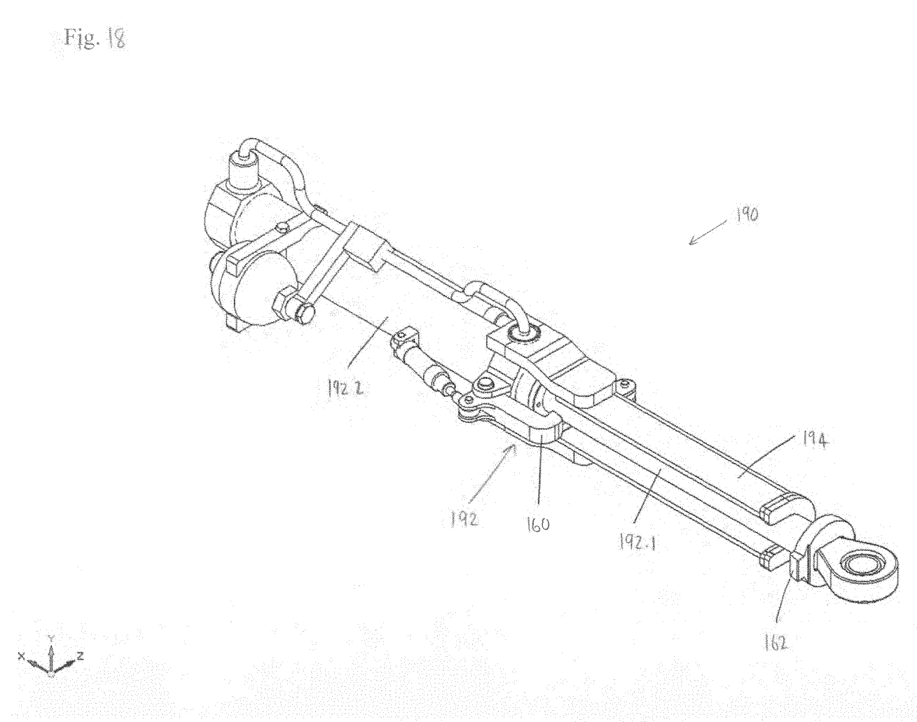

FIG. 18 shows an enlarged three-dimensional view of an elongate actuator assembly in the extended rail-going condition of the second embodiment;

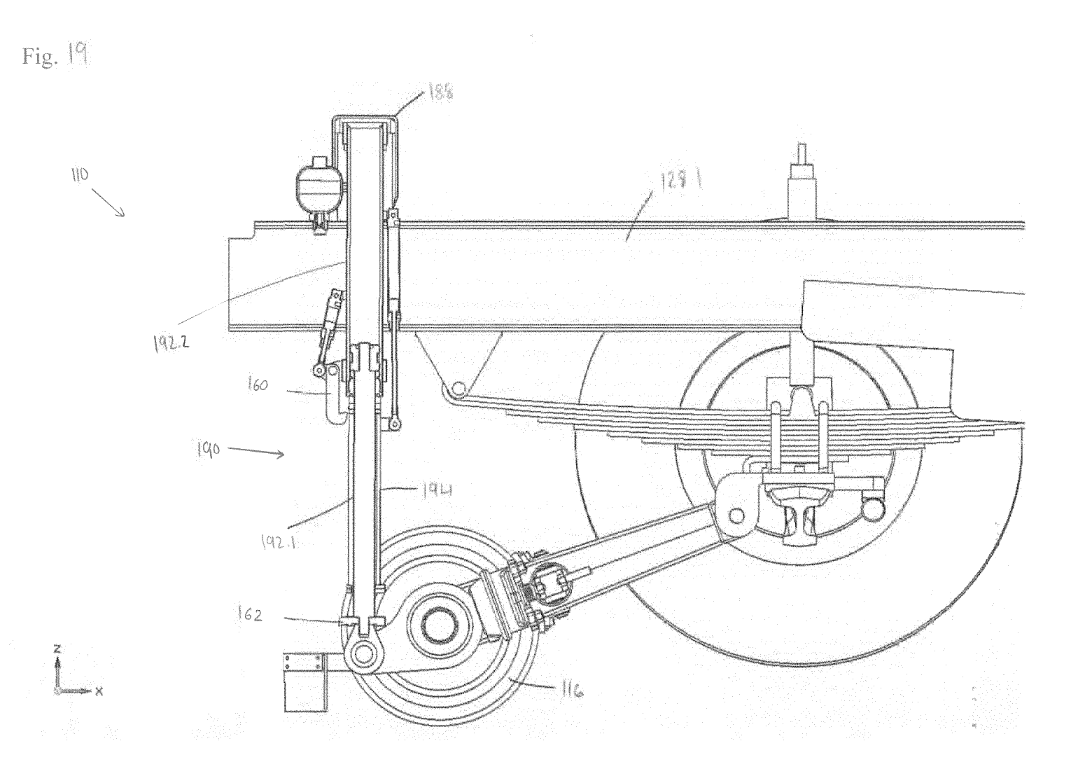

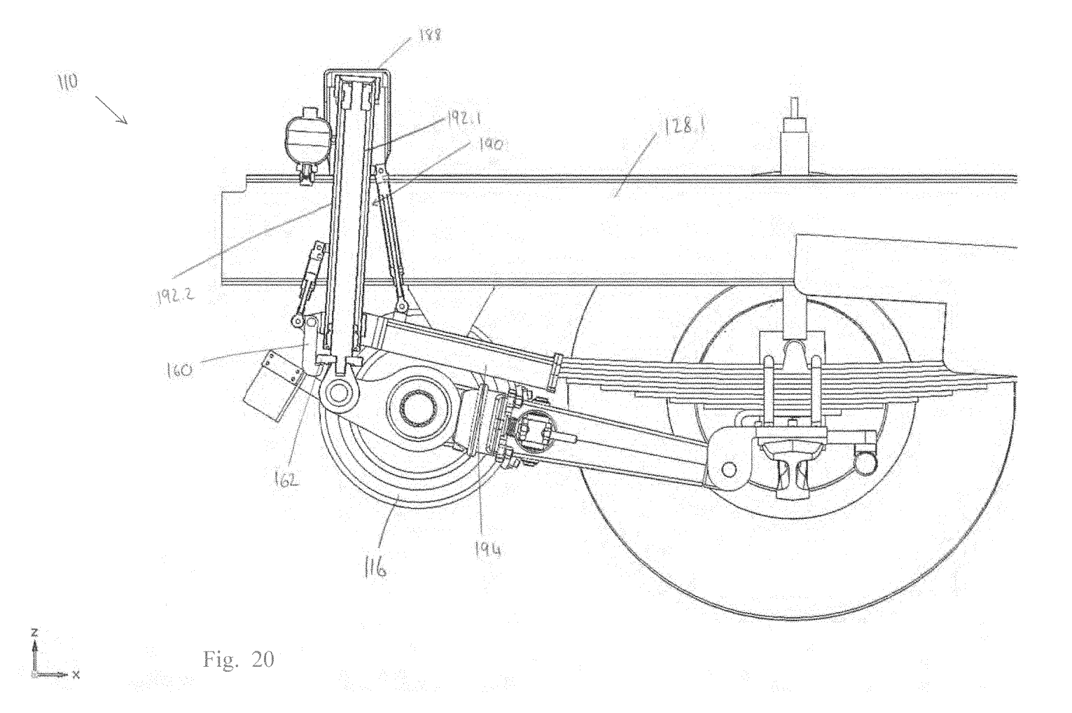

FIGS. 19 and 20 show enlarged sectional side views of a front portion of a road-rail vehicle with the elongate actuator assembly in an extended rail-going condition and a retracted road-going condition, of the second embodiment;

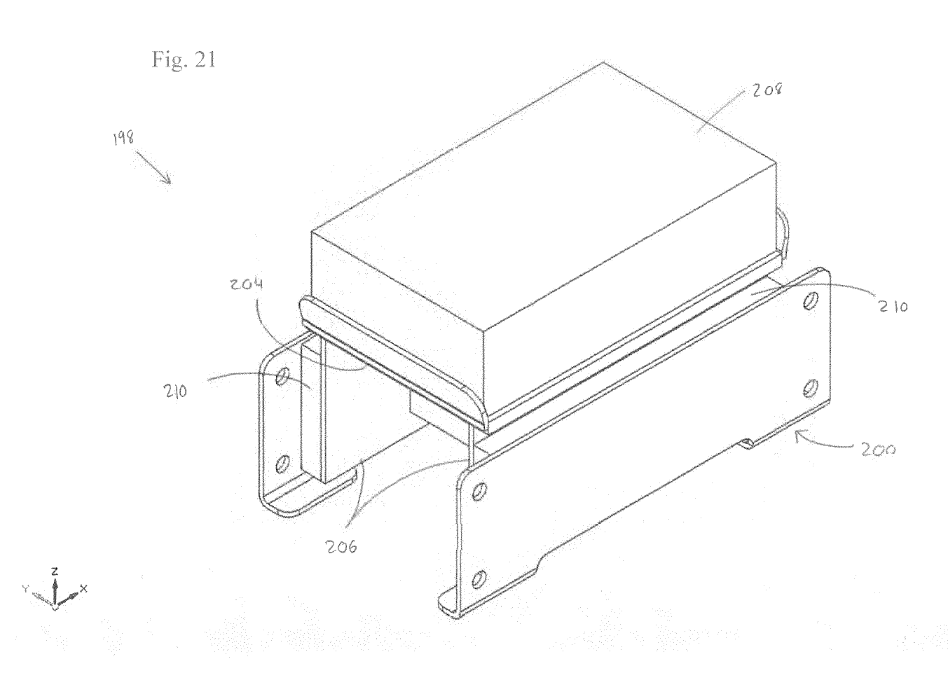

FIG. 21 shows an enlarged three-dimensional view of a rear shock absorbing means of the second embodiment; and

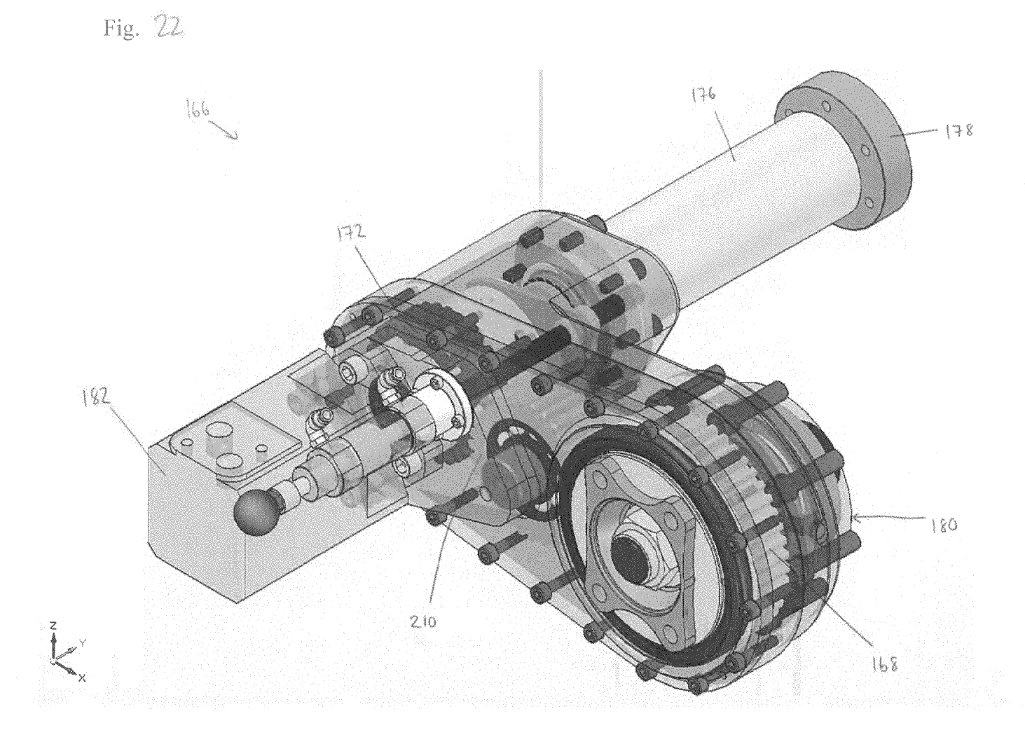

FIG. 22 shows an enlarged, partially transparent, three-dimensional view of the satellite transfer case of the second embodiment.

Referring now to the drawings, reference numeral 10 generally refers to a portion of road-and-rail going vehicle in accordance with the invention.

In particular, the vehicle 10 includes a front rail wheelset 12 in the form of an axle 14 having a pair of rail wheels 16 mounted fast thereon and a generally U-shaped front support frame 18 which is mounted rotatably on the front axle 14. A front mounting means 20 allows arms 18.1 of the front support frame 18 to be mounted on a front road-wheel-assembly 22 of a road-going vehicle. A front displacement means in the form of a front scissor jack assembly 24 is provided for inter-connecting the front support frame 18 and a cross-member 26 of a chassis 28 of the vehicle 10. In particular, the jack assembly 24 is arranged forward the front road-wheel assembly 22. In operation, the jack assembly 24 permits displacement of the front support frame 18 and with it, the front rail wheelset 12, between a rail-going condition wherein the front rail wheels 16 are received complementally a railway track 30 and the front road-wheel-assembly 22 is supported clear of the ground 32, and a retracted road-going condition wherein the front rail wheelset 12 is moved to a position where the front road-wheel-assembly 22 supports the front rail wheelset 12 clear of the ground 32.

The vehicle 10 further includes a rear rail wheelset 34 in the form of an axle 36 having pair of rail wheels 38 mounted fast thereon and a generally U-shaped rear support frame 40 which is mounted rotatably on the rear axle 36. A rear mounting means 42 allows aims 40.1 of the rear support frame 40 to be mounted on a rear road-wheel-assembly 44 of the road-going vehicle. A rear displacement means in the form of a scissor jack assembly 46 is provided for inter-connecting the rear support frame 40 and a cross-member 48 of the chassis 28. The jack assembly 46 is arranged rearward the road-wheel assembly 44. In operation, the jack assembly 46 permits displacement of the rear support frame 40 and with it, the rear rail wheelset 34 between a rail-going condition wherein the rear wheelset 34 is received complementally the railway track 30 and the rear road-wheel-assembly 44 is supported clear of the ground 32, and a retracted road-going condition wherein the rear rail wheelset 34 is moved to a position where the rear road-wheel-assembly 44 supports the rear rail wheelset 34 clear of the ground 32.

The front and rear support frames 18 and 40 include support members 18.2 and 40.2 which span between and interconnect the pairs of arms 18.1 and 40.1 respectively. The front and rear support members 18.2 and 40.2 are sized to correspond with the length of the front and rear axles 14 and 36 respectively and include generally triangular shaped central portions when viewed in plan. Bearing members (not shown) for rotatably interconnecting the front and rear support members 18.2 and 40.2 with the front and rear axles 14 and 36 are arranged towards opposing end regions thereof.

The front and rear mounting means 20 and 42 have generally rectangular base portions with recesses 20.1 and 42.1 defined therein to facilitate complemental fastening to front and rear axles of the front and rear road-wheel-assemblies 22 and 44 respectively. Connecting means 50 allow pivotal interconnection between the base portions 20 and 42 and the arms 18.1 and 40.1 to facilitate displacement of the front and rear rail wheelsets 12 and 34 between the rail engaging and retracted road-going conditions.

The scissor jack assemblies 24 and 46 include opposing scissor linkages 24.1, 46.1 and 24.2, 46.2 respectively and an actuator in the form of a hydraulically energised piston arrangement 52 for displacing the opposing linkages 24 and 46 between the road and rail going conditions.

The linkages 24.1, 46.1 and 24.2, 46.2 be pivotally connected to the cross-members 26, 48 and the support members 18.2, 40.2 via spherical bush-and-bearing arrangements 54 to allow the road and rail axles of the vehicle 10 to remain substantially parallel each other in the road and rail going conditions.

Guide means in the form of gears 56 on opposing linkages 24 and 46 facilitate smooth and uniform guidance during transitional displacement thereof between the rail- and road-going conditions. A retaining means in the form of a latch 60 and complemental catch 62 which extend from opposing junctions of the linkages 24 and 46 are provided for retaining the linkages 24 and 46 in the road-going condition. A moving means in the form of a piston cylinder arrangement 61 may be provided to move the latch 60 out of a latched condition and away from the catch 62 when the rail wheelsets are displaced out of the road-going condition and towards the rail going condition. Holding means in the form of conventional spring members 58 are provided for holding the latch 60 and catch 62 in the latched condition.

A restraining means in the form of a pulley-and-cable arrangement (not shown) for restraining the rear road wheels 44.1 and leaf springs 44.2 of the vehicle 10 in a restrained condition wherein they are moved towards and restrained in position relative the chassis 28 so as to reduce any dynamic effect that may occur through displacement of the rear road wheel assembly 44 when the vehicle 10 is in the rail-going condition. It is to be appreciated that in the rail-going condition, (as shown in FIGS. 1, 3, 5, 7, 8, 9, 10 and 13) the linkages 24.1, 24.2, 46.1 and 46.2 are displaced to an over-centre position which serves to bias the linkages towards the rail-going condition and thus provide a further safety feature to inhibit the displacement of the scissor jacks 24 and 46 towards the road-going condition.

A rail wheel brake system in the form of conventional rail wheel booster brakes 64 are provided for braking of the rail wheels 16 and 38 in the rail going condition.

Referring now to FIGS. 9 to 11, a satellite transfer case 66 for driving the rail wheelsets 12 and 34 of a road-and-rail-going vehicle 10 includes a toothed drive means 68 which is configured to co-operate with and be driven by a drive shaft 70 of the road-and-rail going vehicle 10, a toothed driven means 72 which is configured to co-operate with and be driven selectively, by the drive means 68 via a silent chain 74. The satellite transfer case 66 further includes a rail wheel drive shaft 76 which is configured to co-operate with and be driven by the driven means 72 and a rail wheelset connector 78, in the form of a 90-degree gear drive, for allowing driving interconnection between the rail wheel drive shaft 76 and the rail wheelsets 12 (not shown) and 34 of the road-and-rail going vehicle 10. The satellite transfer case 66 includes a housing 80 for housing at least the drive and driven means 68 and 72 respectively.

A creep drive means 82 is provided for allowing selective creep drive displacement of the rail wheel drive shaft 76 when the vehicle 10 is required to be displaced at a slow speed, during for example, railway track maintenance.

In a second embodiment of the conversion arrangement shown in FIGS. 15-22, reference numeral 110 refers generally to a portion of a rail-and-road going vehicle.

FIGS. 15 and 16 show a rear support frame 140 which includes a strengthening portion in the form of a plate 184 which is located a central portion of the rear support frame 140 for improving the flexural strength thereof. A further strengthening strap 186 for improving the flexural strength of the rear support frame 140 extends between operative underside end regions of the rear support frame 140.

As shown in FIGS. 17-20 a mounting member in the form of a saddle 188 is provided for allowing the front displacement means in the form of an elongate actuator assembly 190 to be mounted on the chassis 128, the saddle 188 being configured to extend between and interconnect opposing longitudinal members 128.1 of the chassis 128 of a road-going vehicle. Additionally, the saddle 188 has opposing end regions 188.1 and 188.2 which are configured to be connectable to the longitudinal members 128.1. More particularly, the location of the saddle 188 forward a front cross-member (not shown) of the chassis 128 is advantageous in that it takes advantage of excess space in a region of an engine (not shown) of the vehicle 110.

The actuator assembly 190 extends between and interconnects the saddle 188 and front support frame 118. The actuator assembly 190 is in the form of a conventional piston and cylinder arrangement 192 which is hydraulically energised between an extended rail-going condition and a retracted road-going condition as shown in FIGS. 19 and 20, respectively.

The actuator assembly 190 includes a retaining means in the form of a latch and catch arrangement 161 for retaining the piston 192.1 and cylinder 192.2 of the piston and cylinder arrangement 192 in the retracted road-going condition. The latch and catch arrangement 161 is located a region intermediate the piston 192.1 and cylinder 192.2.

A safety mechanism in the form of a generally channel shaped shroud 194 is provided for maintaining the piston 192.1 and cylinder 192.2 in an extended rail-going condition in the event of failure of the actuator assembly 190. The shroud 194 is configured to receive the piston 192.1 complementally therein in the extended rail-going condition. The shroud 194 is pivotally displaceable between a safety condition wherein the piston 192.1 and cylinder 192.2 are maintained in the extended rail-going condition and an inoperative condition wherein the shroud 194 is folded away from the piston and cylinder arrangement 192 during the retracted road-going condition.

As shown in FIGS. 15-17, the rail wheel brake system is in the form of conventional pneumatically energised rail wheel brakes 164 having pressure chambers 165 which are arranged to extend outwardly from inner walls 118.1 and 140.1 of the front and rear u-shaped support frames 118 and 140 respectively. The brake system includes a cantilever linkage 196 which extends between the pressure chambers 165 and the front and rear rail wheels 116 and 138 respectively.

As shown in FIGS. 15 and 21, a rear shock absorbing means in the form of a shock absorbing arrangement 198 is provided for absorbing shock loads between the rear displacement means and a rear cross-member 148 of the chassis 128 while the vehicle is moving on the rail 130 in the rail-going condition due to uneven rail surfaces. The shock absorbing arrangement 198 includes a receiving member 200 which is configured to be received complementally a receiving zone 202 of the rear cross-member 148. The receiving member 200 includes a base 204 and a pair of opposing sides 206 which extend from the base 204. Outer facing regions or surfaces of the base 204 and sides 206 are overlayed, substantially, with resiliently deformable members 208 and 210 to facilitate energy absorption of shock loads between the rear scissor jack assembly 146 and the rear cross-member 148. The resiliently deformable members 208 and 210 serve to absorb compressive and shear forces respectively, between the receiving member 200 and the rear cross-member 148.

As shown in FIG. 22, a toothed gear 212 is provided within the satellite transfer case 166 to facilitate driving communication between the drive and driven means 168 and 172 respectively.

The applicant believes that the conversion arrangement in accordance with the invention is advantageous in that it provides a simplified cost effective alternative to road-rail-going vehicles currently available on the market. In particular, the tripod system provided by the displacement means facilitates a reduction of tension and/or stress in the chassis as a result of the rail wheelsets being able to move independently relative thereto. The configuration of the satellite transfer case 66 provide a simplified, space saving alternative for a prime mover or road vehicle which have a centrally located transfer case.

It is to be appreciated that the various arrangements in accordance with invention as shown and described with reference to the accompanying drawings are not limited to the precise functional and/or constructional details as described therein, and may be varied as desired.

1-58. (canceled)

59. A conversion arrangement for converting a road-going vehicle into a vehicle which is also able to travel on a railway, comprising:
a front rail wheelset in the form of an axle having a pair of rail wheels mounted thereon;
a front support frame which is mounted rotatably on the front axle;
a front mounting means for allowing a part of the front support frame to be mounted on a front road-wheel-assembly of a road-going vehicle;
a front displacement means for inter-connecting the front support frame and a cross-member of a chassis of the road-going vehicle arranged forward the front road-wheels and for displacing the front support frame and with it, the front rail wheelset, between a rail-going condition wherein the front rail wheelset is received complementally a railway track and the front road-wheel-assembly is supported clear of the ground and a retracted road-going condition wherein the front rail wheelset is moved to a position where the front road-wheel-assembly supports the front rail wheelset clear of the ground;
a rear rail wheelset in the form of an axle having a pair of rail wheels mounted thereon;
a rear support frame which is mounted rotatably on the rear axle;
a rear mounting means for allowing a part of the rear support frame to be mounted on a rear road-wheel-assembly of the road-going vehicle; and
a rear displacement means for inter-connecting the rear support frame and a cross-member of a chassis of the road-going vehicle arranged rearward the rear road-wheels and for displacing the rear support frame, and with it the rear rail wheelset, between a rail-going condition wherein the rear rail wheelset is received complementally a railway track and the rear road-wheel-assembly is supported clear of the ground and a retracted road-going condition wherein the rear rail wheelset is moved to a position where the rear road-wheel-assembly supports the rear rail wheelset clear of the ground.

60. The conversion arrangement of claim 1, wherein the front and rear support frames are generally U-shaped, each support frame having a pair of arms which extend from support members having a generally triangular shaped central portion when viewed in plan, which support members span between and interconnect the pairs of arms of the respective support frames.

61. The conversion arrangement of claim 1, wherein a strengthening strap for improving the flexural strength of the rear support frame extends generally between operative underside end regions of the rear support frame.

62. The conversion arrangement of claim 1, wherein the front and rear displacement means are in the form of scissor jack assemblies which extend between and interconnect the front and rear chassis cross-members and the front and rear support members respectively.

63. The conversion arrangement of claim 4, wherein the scissor jack assemblies include opposing scissor linkages and an actuator for displacing the linkages between the road- and rail-going conditions.

64. The conversion arrangement of claim 5, wherein the linkages are pivotally connected to the chassis cross-members and the support members via pivotable connecting members.

65. The conversion arrangement of claim 5, which includes a biasing means in the form of conventional spring members, for biasing selectively, the linkages towards the rail- or road-going condition.

66. The conversion arrangement of claim 5, which includes a retaining means for retaining the linkages in the road-going condition.

67. The conversion arrangement of claim 1, wherein a restraining means is provided to restrain the road wheels and leaf springs of the vehicle in a restrained condition wherein the wheels and leaf springs are moved towards and restrained in position relative the chassis so as to reduce any dynamic effect that may occur through displacement of the road-wheel-assembly when the vehicle is in the rail-going condition.

68. The conversion arrangement of claim 1, wherein the front displacement means is the form of an elongate actuator assembly which includes a retaining means for retaining the elongate actuator assembly, in the form of a piston and cylinder arrangement, in the retracted road-going condition.

69. The conversion arrangement of claim 10, wherein the retaining means is in the form of a latch and catch arrangement which is located a region intermediate a piston and cylinder of the piston and cylinder arrangement.

70. The conversion arrangement of claim 11, wherein a safety mechanism in the form of a shroud is provided for maintaining the piston and cylinder in an extended rail-going condition in the event of failure thereof, the shroud being configured to receive the piston complementally therein in the extended rail-going condition.

71. The conversion arrangement of claim 12, wherein the shroud is displaceable between a safety condition wherein the cylinder and piston are maintained in the extended rail-going condition and an inoperative condition wherein the shroud is folded away from the piston and cylinder during the retracted road-going condition.

72. The conversion arrangement of claim 9, wherein a mounting member in the form of a saddle is provided for allowing the actuator assembly to be mounted on the chassis of the road-going vehicle, the mounting member being configured to extend between and interconnect opposing longitudinal members of the chassis, the saddle having a generally arcuate central portion and opposing end regions which are configured to be connectable to longitudinal members of the chassis so as to take advantage of space constraints in a region of an engine of the vehicle.

73. A drive arrangement for driving rail wheels of a road-and-rail-going vehicle which drive arrangement comprises:
a drive means which is configured to co-operate with and be driven by a drive shaft of the road-and-rail-going vehicle;
a driven means which is configured to co-operate with and be driven, preferably selectively, by the drive means;
a rail wheel drive shaft which is configured to co-operate with and be driven by the driven means; and
a rail wheelset connector for allowing driving interconnection between the rail wheel drive shaft and a rail wheelset of the road-and-rail-going vehicle.
